(19) United States
(12) Patent Application Publication
(10) Pub. No.: US 2010/0298957 A1
(43) Pub. Date: Nov. 25, 2010

(54) MULTI-FUNCTION SENSOR FOR HOME AUTOMATION

(75) Inventors: Jaime Sanchez Rocha, MEXICO CITY (MX); Alejandro Romero Vargas, Temixco Morelos (MX)

Correspondence Address: GRAYBEAL JACKSON LLP, 400 - 108TH AVENUE NE, SUITE 700, BELLEVUE, WA, 98004, US

(73) Assignee: SYNERGY ELEMENTS, INC., EVERETT, WA (US)

(21) Appl. No.: 12/781,745

(22) Filed: May 17, 2010

Related U.S. Application Data
(60) Provisional application No. 61/178,889, filed on May 15, 2009.

(51) Int. Cl. G06F 17/00

(52) U.S. Cl. 700/90

(57) ABSTRACT

A multi-function sensor for a home automation system includes a plurality of sensors and a network interface configured to transmit data over a mesh radio network responsive to a value read from at least one of the plurality of sensors.

### PRIORITY CLAIM

The present application claims priority to U.S. Provisional Patent Application No. 61/178,889, filed May 15, 2010, which application is incorporated herein by reference in its entirety.

### SUMMARY

In a home automation system, several components may communicate to control electrical circuits and/or actuators. According to an embodiment, a multi-function sensor includes a plurality of sensors configured to sense corresponding parameters in a room. Data corresponding to the sensed parameters may be transmitted to other components of a home automation system, for example via a radio frequency interface such as ZigBee™.

According to an embodiment, a multi-function sensor for a home automation system includes a network interface configured for data communication with one or more home automation modules; a plurality of sensors configured to measure a plurality of conditions in a room; and an electronic controller operatively coupled to the network interface and the plurality of sensors and configured to control operation of one or more of the network interface and the plurality of sensors.

According to an embodiment, a method for operating a multi-function sensor includes receiving an addressed inquiry from a home automation network resource; waking up multi-function sensor circuitry from a sleep state; reading at least one sensor value; transmitting data responsive to the at least one sensor value; and re-entering the sleep state.

According to an embodiment, a method for operating a multi-function sensor includes receiving a first command via a network interface and, responsive to the first command, performing a plurality of sensor operations.

According to an embodiment, a method for operating a multi-function sensor includes receiving a system tick; waking from a sleep mode responsive to receiving the system tick; reading a sensor value; transmitting data to a home automation system responsive to the sensor value; and entering the sleep mode.

According to an embodiment, a multi-function sensor includes a network interface and at least one sensor interface operatively coupled to the network interface and configured to receive digital or analog signals from at least one external sensor; wherein the network interface is configured to communicate data over a mesh radio network responsive to a signal received through the at least one sensor interface.

### BRIEF DESCRIPTION OF THE FIGURES

FIG. 1 is a block diagram of a multi-function sensor for home automation, according to an embodiment.

FIG. 2A is a flowchart of a process for operating the multi-function sensor of FIG. 1 responsive to an inquiry from another system resource, according to an embodiment.

FIG. 2B is a flowchart of a process wherein the multi-function sensor of FIG. 1 may respond to a program query and/or download program instructions from another system resource, according to an embodiment.

FIG. 2C is a flowchart of a process for operating the multi-function sensor of FIG. 1 to transmit sensor values to another system resource without external prompting, according to an embodiment.

FIG. 3 is a perspective view of an electronics assembly for the multi-function sensor of FIG. 1, according to an embodiment.

FIG. 4A is a perspective view of the multi-function sensor of FIGS. 1 and 3, according to an embodiment.

FIG. 4B is a top view of the multi-function sensor of FIGS. 1, 3 and 4A, according to an embodiment.

FIG. 5 is an orthographic view of a multi-function sensor configured to at least optionally receive AC power, according to an embodiment.

FIG. 6 is a block diagram of a multi-function sensor configured to at least optionally receive AC power, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

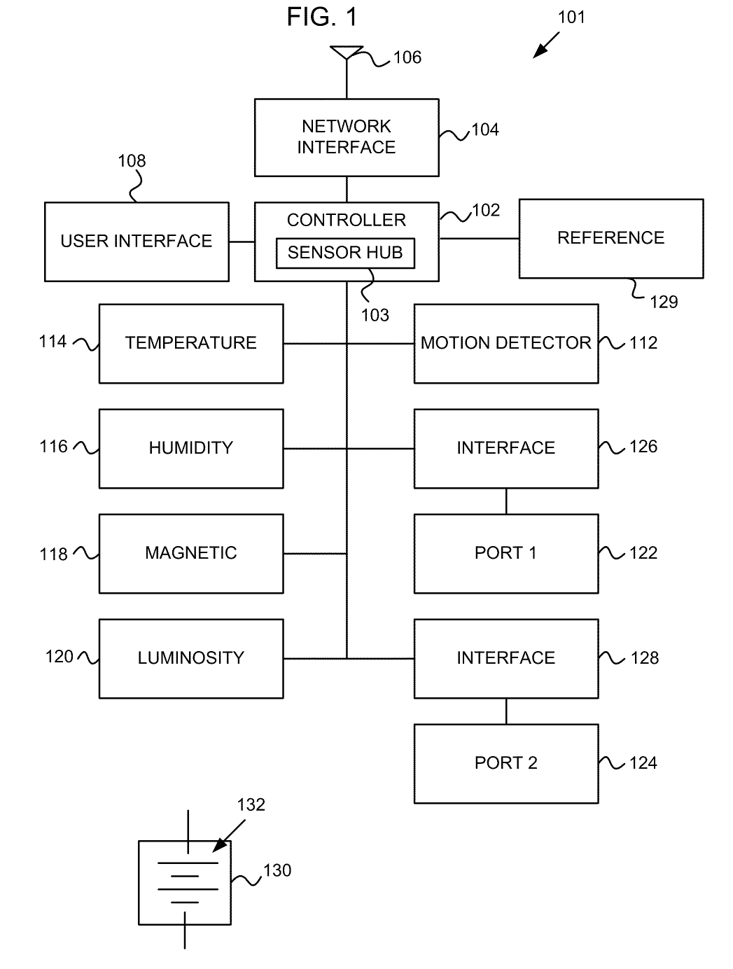

FIG. 1 is block diagram of a multi-function sensor for home automation 101, according to an embodiment. According to an embodiment, the multi-function sensor 101 includes a controller 102. The controller 102 is operatively coupled to a network interface 104. The network interface 104 may include an unlicensed radio interface such as ZigBee™, Bluetooth, IEEE 802.11X, Z-wave, or the like. The network interface 104 may also include one or more antennas 106 configured to receive and/or transmit data signals from and/or to other components of the home automation system. For example, the one or more antennas 106 may be formed as electrical traces disposed on a printed circuit board supporting the controller 102 and network interface 104.

According to an embodiment, at least a portion of the controller 102 and at least a portion of the network interface 104 are combined on a single integrated circuit. According to an embodiment, the network interface 104 and the controller 102 are substantially combined on a single integrated circuit plus peripheral circuitry. For example, the controller 102 and network interface 104 may be embodied as a FREESCALE™ part number MC13213. Alternatively, the controller 102 and network interface 104 may be embodied as separate parts. For example, a network interface 104 may be embodied as a FREESCALE™ part number MC13202 transceiver. For example, a separate controller 102 may be embodied as an ARM microcontroller. For example, a separate controller 102 may be embodied as a FREESCALE™ part number MC9S08QE 8-bit microcontroller.

A user interface 108 may receive control and/or inquiry input from a user. The user interface 108 may also provide information to the user. For example the user interface 108 may include one or more LED indicator lights and one or more buttons. Optionally, the user interface 108 may include a display such as a LCD display configured to present simple messages to the user.

The controller 102 is operatively coupled to a plurality of sensors. According to an embodiment, the plurality of sensors may include a motion detector 112, a temperature sensor 114, a humidity sensor 116, a magnetic sensor 118, and a luminosity sensor 120. According to an embodiment, the controller 102 may be operatively coupled to one or more sensor inputs 110.

According to an embodiment, the motion detector 112 may include a conventional pyroelectric infrared motion detector such as a model D203B radial sensor available from PIR SENSOR CO., LTD.™, for example. The motion detector may be mounted behind a Fresnel lens such as a part code FRESNEL available from FUTURLEC™. The luminosity sensor may include an opto-electric device such as conventional PIN photodiode or a phototransistor. For example the luminosity sensor may include a TAOS™ part number TSL2561T available from MOUSER ELECTRONICS, INC.™ Optionally, the optoelectric device may receive light through a filter tuned to pass visible light. The filter tuned to pass visible light may for example include one or more of a notch filter, a low pass filter, a hot mirror, a high pass filter, a cold mirror, a gel filter, a birefringent filter, a reflective filter, and/or a composite filter. Optionally, one or more powered optical elements may be positioned to relay light to the sensors. For example a powered optical element may include one or more of a Fresnel lens (as mentioned above), a binary optic, a bulk optic, a refractive optic, a mirror optic, a diffractive optic, a grating, a fixed optic, a zoom optic, a molded-in optic, a pinhole lens, a spherical lens, a cylindrical lens, a polynomial lens, an aspherical lens, a non-linear optic, a negative refractive index surface, a Newtonian optical relay, a light pipe, a waveguide optic, a waveguide bundle, and/or a compound optic.

The temperature and humidity sensors 114, 116 may be combined on a single integrated circuit, or may alternatively be include separate parts. For example, the temperature sensor 114 may include an ANALOG DEVICES™ part number ADT75 or ADT75ARMZ. The humidity sensor 116 may include a capacitive cell relative humidity sensor such as part number HS1101LF, available from MEASUREMENT SPECIALTIES™ of Toulouse, France.

The magnetic sensor 118 may be configured to receive a change in magnetic field responsive to a magnet moving near or away from the multi-function sensor 101. For example, multi-function sensor 101 may be positioned near a door (not shown), and a permanent magnet (not shown) may be attached to the door, thus sensing whether the door is open or closed. According to an embodiment, the magnetic sensor 118 may include a HONEYWELL™ two axis magnetic sensor model number HMC1052L.

According to embodiments, other sensors may be added and/or substituted for sensors described above. For example, one or more of a digital still or video camera, a microphone, a carbon dioxide sensor, a carbon monoxide sensor, a radon gas sensor, and/or an ionization or transmissivity (smoke detector) sensor may be integrated into the multi-function sensor 101.

The combination of integrated sensors described above may provide a home automation system with information with substantially all information about a given room necessary select parameters with a high degree of certainty to control the environment of the room and/or neighboring rooms. For example, the motion detector may be used to determine if the room is occupied. If the room is unoccupied, lights may be turned off automatically. If sensors in other rooms indicate a home is unoccupied, the temperature of one or more of the rooms may be allowed to change to a lower energy consumption state, and/or a robotic vacuum deployed to clean a room. If luminosity indicates a room is bright and an increased temperature is detected, the home automation system may close window blinds to reduce solar gain. Compared to installation of separate sensors and integrating the separate sensors into a home automation system, the multi-function sensor 101 may allow installation by untrained personnel, such as a homeowner.

According to an embodiment, the multi-function sensor 101 may include two external sensor ports 122, 124. The two external sensor ports 122, 124 may include multi-function ports configured to receive serial digital data or analog data. For example, the ports 122, 124 may include dedicated serial digital data transmission pins and dedicated analog pins. Interfaces 126, 128 may provide interconnection between the external sensor ports 122, 124 and the rest of the multi-function sensor 101. The interfaces 126, 128, which may be combined or separate, may include one or more analog-to-digital converters (ADC) for the ports 122, 124. Alternatively, the controller 102 may include ADC functionality for converting analog signals received through the ports 122, 124 to digital signals.

The inclusion of external sensor ports 122, 124 may provide for easy integration of third party sensors into a home automation framework. According to an embodiment, automatic or semi-automatic configuration logic may allow various third party sensors to be easily integrated into the home automation system without extensive programming or knowledge about the characteristics of signals delivered by the external sensors.

According to an embodiment, the controller 102 includes a sensor hub 103. The sensor hub may be formed as software or firmware configured to manage the sensors and ports. Each sensor and interface port may be configured as an addressable end device. The addressable end devices may be referred to as drones. A drone may be an analog or a digital device. For cases where the drone is an analog device, and optionally for cases where the drone is a digital device, the sensor hub 103 maintains a record of a logical address assigned to the drone. Digital drones may optionally maintain a local logical address.

For example, the multi-function sensor 101 may include a temperature-dependent resistor configured as a temperature sensor 114. The temperature-dependent resistor may be coupled to a known first physical port on the controller 102 that the sensor hub 103 has a record of. In a new multi-function sensor 101, the sensor hub 103 may include data indicating a temperature-dependent resistor coupled to the first port, and one or more reference devices 129 such as a reference resistor coupled to a second port. The sensor hub 103 may additionally include calibration information such as the temperature dependence of the temperature-dependent resistor. The multi-function sensor 101 may be installed in a bedroom “bedroom1”.

When installed, a ZigBee™ discovery process may alert a network controller (not shown) that a new device is on the network. Typically during such discovery, the device MAC address may be used for joining the network. The multi-function sensor may then receive a logical address such as “bedroom1_MF” from the network controller. The sensor hub 103 may then report the existence of a temperature sensor 114. The network controller may assign a logical address to the temperature sensor 114 “bedroom1_temp”. During operation, the network controller may transmit an addressed inquiry to “bedroom1_temp”. The sensor hub measures the resistance across the temperature-sensitive resistor on the first port and compares it to the reference resistance on the second port. The sensor hub may determine a data value based on calibration information. The sensor hub then provides the sensor information to the network interface 104, which reports the temperature data to the system controller (not shown)

Other drones may similarly be coupled to the network as addressable end devices. Optionally, calibration information or other operational data may be stored on a database in the system controller. In such a case, the sensor hub may report raw data, such as a voltage on the temperature dependent resistor, to the system controller, and the system controller may calculate a temperature from the raw data.

The multi-function sensor 101 may include a battery holder 130 configured to receive one or more batteries 132 for powering the multi-function sensor 101. For example, the battery holder 130 may be configured to receive three AAA cells. The AAA cells may be conventional alkaline, NiCd, NiMH, lithium-ion, lithium polymer, or other battery types.

Optionally, a DC power connector (not shown) may be provided to receive external power. It may be advantageous to provide external power especially when the multi-function sensor 101 is deployed in a remote, hazardous, or otherwise inaccessible location where changing batteries every few months or years may be difficult. Alternatively, it may be advantageous to provide external power through the DC power connector in applications where battery life may be reduced, such as where frequent sensor input is needed.

According to an embodiment, the multi-function sensor 101 may include a photovoltaic device (not shown) configured to provide charging current to the batteries and/or other circuitry upon receiving ambient light from the room. Alternatively, another charging apparatus such as a thermocouple charge pump or an electro-hydrodynamic device may be configured to recharge rechargeable batteries 132. Such embodiments may provide for operation for substantially the life of the batteries.

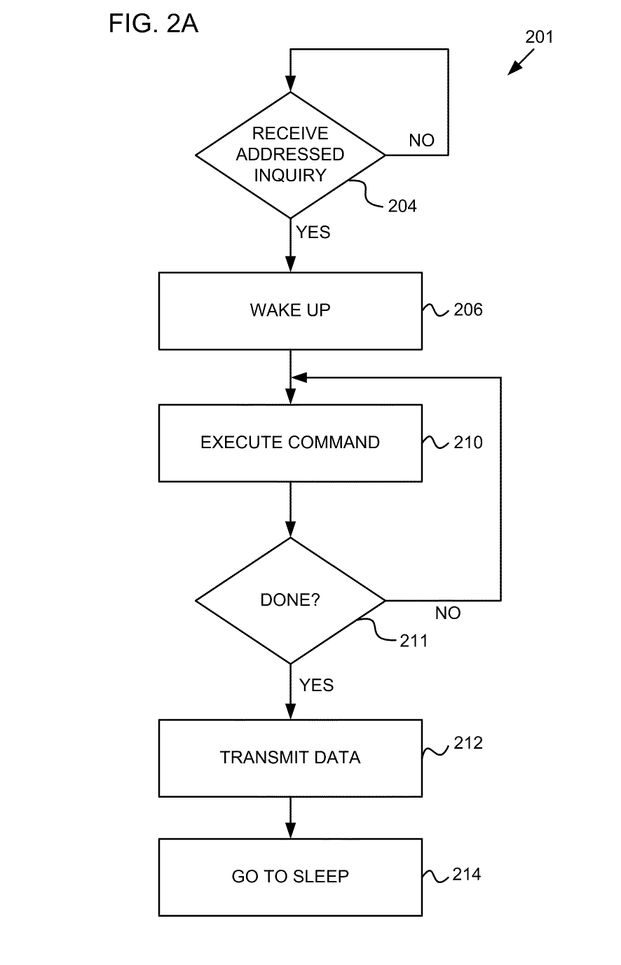

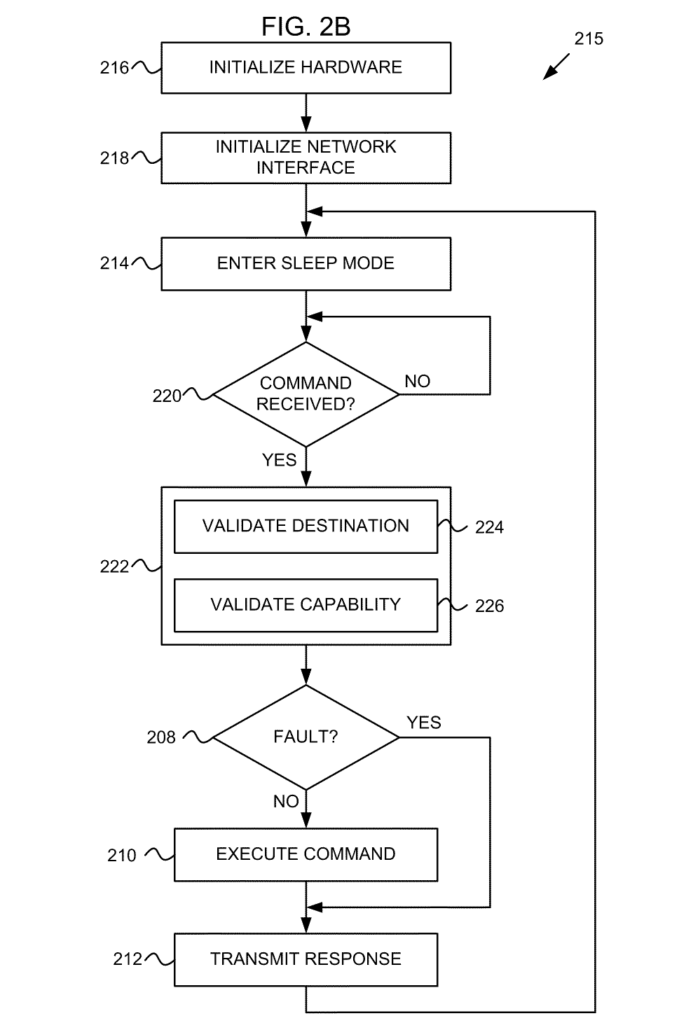

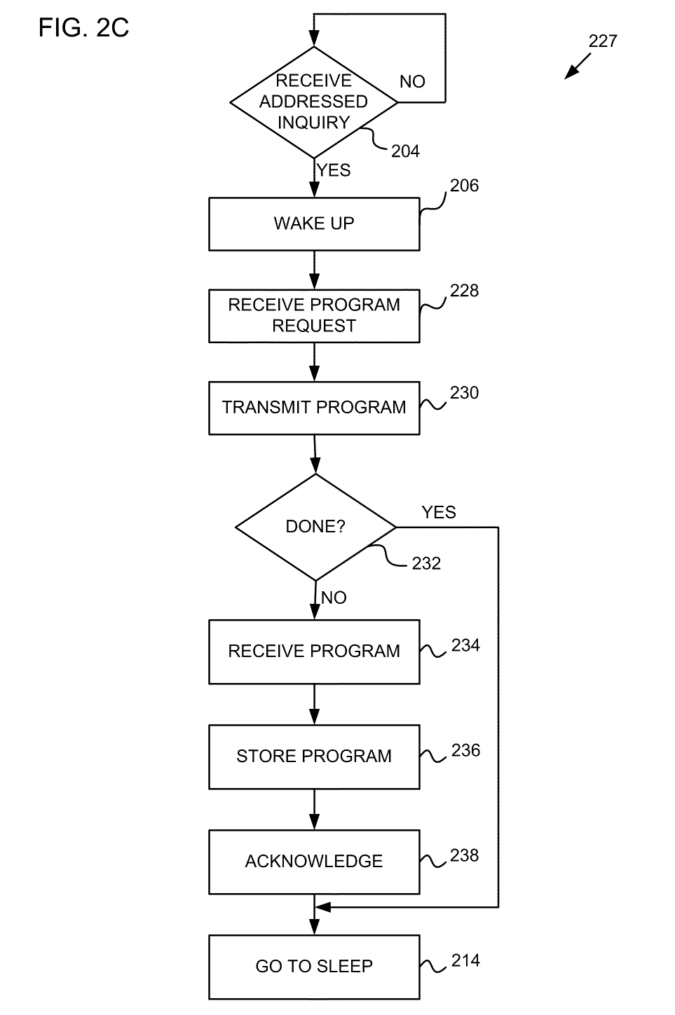

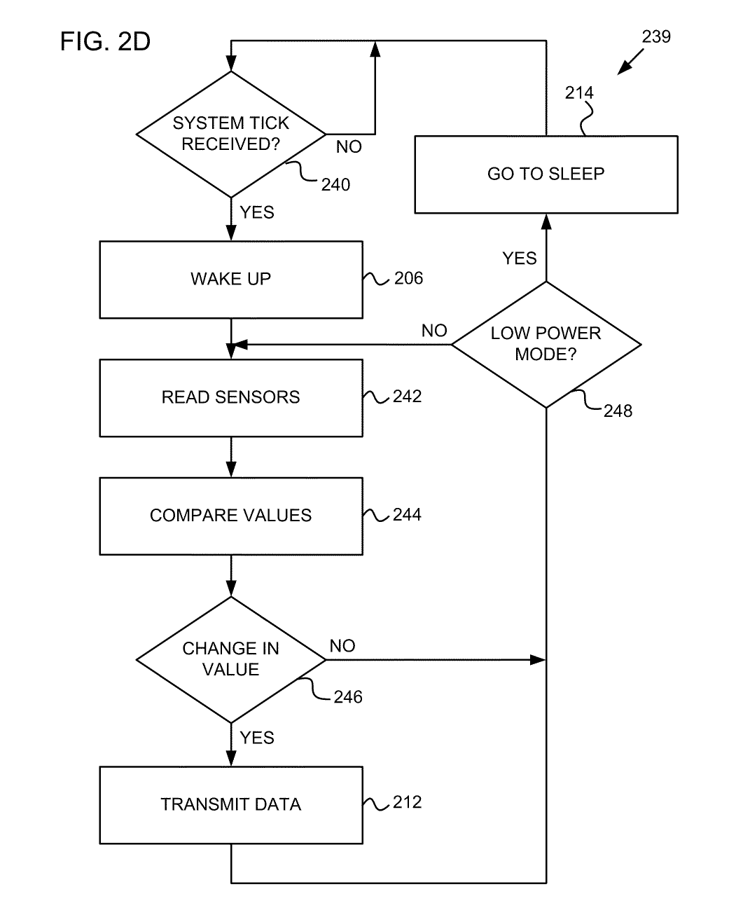

FIG. 2A is a flowchart of a process 201 for operating the multi-function sensor 101 of FIG. 1 responsive to an inquiry from another system resource, according to an embodiment. The process of FIG. 2A may be used, for example, in an embodiment of the multi-function sensor 101 having a hardware wake-up circuit.

FIG. 2A is a flowchart of a process 201 for operating the multi-function sensor of FIG. 1 responsive to an inquiry from another system resource, according to an embodiment. According to embodiment, (referring to FIG. 1), one or more of the controller 102, the network interface 104, the user interface 108, and the sensors may be configured to consume little or no power when not activated to sense, communicate a sensed value, respond to an inquiry, and/or communicate information to a user. For example, the multi-function sensor 101 may typically operate in a low power mode such as a sleep state.

In the sleep state, substantially only a small portion of the network interface 104 including a wake-up circuit may remain active. The wake-up circuit executes step 204 wherein received radio frequency messages are compared to a communication address of the multi-function sensor 101. The communication address of the multi-function sensor 101 may, for example, include a MAC address and/or logical address stored in the network interface 104 or other assigned address that may be accessed without waking other portions of the multi-function sensor 101. If a received radio frequency message does not include data indicating it is addressed to the multi-function sensor 101, then the wake-up circuit continues to execute step 204 without responding and without waking other portions of the multi-function sensor 101. If a received radio frequency message does include data indicating the message is addressed to the multi-function sensor 101, then the process 201 proceeds to step 206.

Optionally, the multi-function sensor 101 may include one or more drones formed as individual sensors. An addressed inquiry received in step 204 may include an inquiry to a drone address. The drone address may be held in a sensor hub 103 described in conjunction with FIG. 1. The wake-up step 206 described below may refer to activating circuitry associated with the drone.

In step 206, the wake-up circuit in the network interface outputs a command or signal selected to wake the remainder of the network interface 104. Upon being activated, and still in step 206, the network interface 104 may optionally receive and/or transmit one or more handshake messages with the radio transceiver that initiated the communication. If the message is a ping or other message that does not require further action by the multi-function sensor 101, the process 201 may optionally proceed substantially directly from step 206 to step 214 and the network interface 104 may go back to sleep without consuming significant additional power.

Optionally, if a system fault is detected, the process 201 may proceed directly to step 212 to transmit a message indicating the fault. For example, if battery power is too low to operate a sensor or if sensing may reduce battery power below what is required to operate the network interface 104 and/or controller 102, the process 201 may proceed to step 212 to notify the system that batteries need to be changed. If no fault is detected, the process 201 may proceed to step 206.

Proceeding to step 206, the controller 102 receives a wake-up command. For example, waking the network interface 104 prior to waking the controller 102 may allow faster response to a message, and less power consumption in the event controller wake-up is not needed. Alternatively, steps 204 and 206 may be executed substantially simultaneously.

The process 201 next proceeds to step 210 wherein the multi-function sensor 101 executes a received command such as by reading one or more sensors responsive to the inquiry received in step 204. According to an embodiment, the controller 102 may read two or more sensors 112, 114, 116, 118, 120, and/or external sensors operatively coupled to port 1 122 and/or port 2 124 responsive to a single addressed inquiry received in step 204.

According to an embodiment, the addressed inquiry may specify reading a single sensor (such as by addressing the inquiry to a drone), may imply or specify reading all sensors, or may specify reading a subset of sensors. Additionally or alternatively, the multi-function sensor 101 may be programmed to read one, all, or a subset of sensors responsive to an addressed inquiry from a given network module. For example, if network module operable to control a furnace or air conditioner transmits an addressed inquiry to the multi-function sensor received in step 204, and the network address of the inquiring device is included in the message, then the multi-function sensor 101 may be programmed to read a temperature sensor only. Or, for example, if a network module including a master controller transmits the addressed inquiry to the multi-function sensor received in step 204, then the multi-function sensor 101 may be programmed to read all sensors.

Proceeding to step 210, a command received in step 204 (or a preselected command or series of commands set during configuration of the multi-function sensor) is executed. Typically execution of commands in step 210 includes reading one or more sensors. Optionally, process 201 (and process 212 of FIG. 2B) may be programmed to operate at least a second sensor responsive to one or more values or functions of values sensed by one or more first sensors.

After executing step 210, the process proceeds to step 211. If fewer than all specified sensors have been read, if plural readings from a given sensor are desired, and/or if one or more first sensor values determine that at least a second sensor should be read, the process loops back to step 210. If the sensor or sensors to be read have been read, then the process proceeds from step 211 to step 212 where the sensor data or data corresponding to the sensor data is transmitted. Depending on programming, such transmission may include an addressed transmission, such as a response to the network module that sent the inquiry. The transmission in step 212 may alternatively include a broadcast transmission.

After transmission of the sensor data in step 212, if the multi-function sensor 101 is in a low power mode of operation, then the process proceeds to step 214, where the multi-function sensor 101 again enters a sleep state.

As indicated above, the multi-function sensor may, according to some embodiments, be programmed to respond to an inquiry in a desired way. Alternatively, as will be made clear with reference to FIG. 2D, the multi-function sensor may be programmed to initiate data transmission.

FIG. 2B is a flowchart of a process 215 for operating the multi-function sensor 101, according to another embodiment. The process 215 illustrates an initialization process that may also be performed (but is not shown) with the process 201 shown in FIG. 2A. The process 215 of FIG. 2B may be performed, for example, in an embodiment of the multi-function sensor 101 not having a separate wake-up circuit.

Beginning in step 216, in a hardware initialization state all hardware is turned on and initialized. Default states for sensors and/or communication (e.g. pre-emptive or responsive) are set. The default values may be configured from an external system through a device interface, which may receive the values from a user or a network. When the network components are initialized, the process 215 proceeds to step 218.

In step 218, the device may register in a network. If this is not the first time this device runs the initial sequence, a previous registration setting may be retrieved from the system. Functional configuration may also set, according to device capabilities. If configuration profiles are available on the network, the multi-function sensor 101 may retrieve these settings from a remote location.

After the multi-function sensor has been initialized, the process 215 proceeds to step 214, and multi-function sensor goes to a low power or “sleep” mode.

In sleep mode, the network interface receives messages such as radio frequency messages transmitted by other system resources. When no messages are received, the system loops at step 220 in a mode that minimizes power consumption. When a command is received, the process 215 proceeds to step 222.

Step 222 is a validation step that includes two types of validation. Step 224 is a destination validation and step 226 is a capability validation. In step 224, the device validates the packet destination. For example, the destination of the received command may be compared to a MAC address and/or logical address. Step 224 may also evaluate functionality published on the network. According to the ZigBee™ standard, clusters are an abstraction of local functionality. Such capability is available to remote devices on the network that can control a cluster. Further detail is available in the ZigBee™ Specification, available from the ZigBee™ Alliance, which incorporated herein by reference.

If it is determined that the packet received contains a valid destination that refers to the local device, then system capability is evaluated in step 226. For example, in step 226, the received command may be compared to the configuration profile of the multi-function sensor. This may include more advanced and/or specific criteria. For example, a multi-function sensor may be exposed to the network as a particular abstraction, but only a limited set of commands are compliant with the functional profile. In this scenario the abstraction capabilities may be validated by the network component, while the specific command may be validated by the behavior implementation and hardware control components.

The process next proceeds to step 208, where the results of validation are tested. If validation is made (i.e. if a fault is not detected), the process proceeds to step 210, where the command is executed. After execution of step 210, or if a fault is detected in step 208, the process proceeds to step 212 where a response is transmitted to the network. A response packet may include the success or unsuccessful result of attempting to execute a command. It also may include report of the system status. Operation of step 210, may be performed as described in conjunction with FIG. 2A.

FIG. 2C is a flowchart of a process 227 wherein the multi-function sensor of FIG. 1 may respond to a program query and/or receive program instructions from another system resource, according to an embodiment.

Steps 204 and 206 may proceed as described above in conjunction with FIG. 2A. Alternatively, a connection may be made via a digital portion of an interface 126, 128. For example, this may be especially useful when configuring multi-function sensors during assembly, such as for loading BIOS or other program code, for testing, and/or for configuring multi-function sensors during deployment in a home environment. According to an embodiment, certain types of programming, such as loading a MAC address or other basic programming may substantially be performed only via a hard-wired port 122, 124. Optionally, such basic programming may further require setting a hardware jumper or other extraordinary steps that may prevent inadvertent programming of low level data (possibly permanently disabling the multi-function sensor) in an uncontrolled environment.

According to an embodiment, the process 227 may include steps 228 and 230. Optionally, steps 228 and 230 may be omitted. In step 228, the multi-function sensor may receive a program request. For example, a program request may include a request to upload a listing of user-configurable commands currently loaded in memory in the multi-function sensor. Proceeding to step 230, the multi-function sensor may respond to step 228 by transmitting the requested program instructions to the requesting device. The process 217 then proceeds to step 232. If the transaction is done, the program may proceed to step 214, wherein at least portions of the multi-function sensor circuit goes to sleep. Optionally, the loaded program may not include at least some power saving functions, and the program may continue to operate as determined by local programming instructions.

Optionally, some or all of steps 204, 206, 228, 230, and 232 may be omitted. For example if the multi-function sensor is configured for a low powered operation mode, but there is no request for program information, the process 217 may proceed from step 204 to step 206, to step 234.

Proceeding to step 234, the multi-function sensor may receive a program and/or operating configuration. For example, during step 234, flash memory or other non-volatile memory in the controller 102 may be programmed to monitor one or more of the sensors in the multi-function relay, to ignore one or more of the sensors in the multi-function relay, to respond to an addressed inquiry according to a conditional response state, to operate according to a low power mode of operation such as according to the process 201 of FIG. 2A, to operate according to a operation without external prompting mode of operation such as according to the process 239 of FIG. 2D, to observe one or more sensor value changes corresponding to a sensor value reporting condition, to use one or more maximum or minimum sensor value set points corresponding to an operation initiation, to receive calibration information, to receive a logical address, and/or to operate or communicate according to another operating parameter.

Proceeding to step 236, which may for example occur iteratively or substantially simultaneously with step 234, the received program instructions may be saved in memory. Proceeding to step 238, the multi-function sensor may acknowledge receipt of the program instructions. For example, step 238 may include calculating and transmitting a checksum and/or may include transmitting a program version designation that has been received. Optionally, step 238 may be performed while program instructions are held in volatile memory and before the have been saved in step 236, such as to avoid loading corrupted instructions into non-volatile storage. Optionally, step 238 may be performed iteratively with step 234 and/or 236. After step 238, the transaction may be complete, and the process 227 may proceed to step 214, wherein the multi-function sensor enters a sleep state. Alternatively, the multi-function sensor may continue to operate as configured without entering a sleep state.

FIG. 2D is a flowchart of a process for operating the multi-function sensor of FIG. 1 to transmit sensor values and/or other data to another system resource without external prompting, according to an embodiment. Optionally the multi-function sensor may operate in a low power mode. In the low power mode, a portion of the controller and/or the network interface executes step 240, where the circuit looks for a system tick. For example, a portion of the controller or external circuitry may execute a clock function such as a countdown and look for the system tick. Alternatively, the multi-function sensor may rely on periodic polling from another network resource to act as the system tick. As long as a system tick is not received (and optionally, as long as no other alarm condition is received (not shown), the system may remain in step 240. At intervals, such as once every second, once every 10 seconds, once a minute, etc., a system tick may be received, whereupon the process 239 proceeds to step 206.

In step 206, a wake-up signal may be generated and the controller may move from a sleep state to an operating state. The process 239 then proceeds to step 242, wherein the controller reads one or more sensors. The sensors that are read may include all sensors, a subset of sensors, and/or the sensors may be read according to a plurality of corresponding schedules such as to vary according to time of day or iteration of the system tick. For example, the motion detector may be read every system tick, but the temperature sensor may be configured to read every other system tick. According to an embodiment, the process 239 may choose to read at least a second sensor responsive to one or more values or functions of values sensed by one or more first sensors.

To reduce the rate of reading a particular sensor, for example, the controller may be configured to increment N flag bits by one. If a two flag bits are used, an intermittently read sensor may be read when the bit values equal 00. The next time a system tick is received, the bit value may be incremented to 01, then 10, then 11, not reading the intermittently read sensor when the bit values do not equal 00. Responsive to the next system tick, the bit value may be incremented by 1 from 11 to again equal 00, whereupon the intermittently read sensor is again read.

Proceeding to optional step 244 the value read from a sensor may be compared to a previously sensed value or to a set point or limit value. The program 239 then proceeds to step 246. If the read value exceeds or falls below a set point, exceeds or falls below a limit value, if the sensed value has changed since the previous read, if the sensed value has changed by more than a resolution value since the previous read, and/or if a statistical function of the current read and the previous reads meets a reporting condition, the process 239 proceeds from step 246 to step 212, wherein data is transmitted to another network resource. If a condition for reporting is not met, the process 239 proceeds to step 248.

The conditions for reporting a change in sensor reading may optionally be programmable. Alternatively, step 244 and/or step 246 may be omitted, and the sensor value (optionally, if a sensor value was read during the current system tick cycle or current continuous operation cycle) determined in step 242 may unconditionally result in data being transmitted in step 212. Data transmitted in step 212 may correspond to a sensor value, may correspond to a response variable value, and/or may correspond to a change in sensor value, for example. Optionally, subsequent interrogation by a network resource (not shown) may result in additional data being transmitted. Therefore, step 212 may optionally correspond to a plurality of data transmission events to and from one or more other network resources.

Following step 246 or step 212, the program proceeds to step 248. In step 248, if the multi-function sensor is not in a low power operation mode wherein it periodically enters a sleep state, the program loops to step 242, where one or more sensors is again read. Such non-low power mode of operation may, for example, be entered responsive to an intruder condition, a fire alarm condition, a system test condition, and/or other urgent or other continuous monitoring condition. Thus, according to configuration program instructions loaded in the multi-function sensor, the response condition to step 248 may be determined according to sensor values read in one or more previous steps 242 and/or comparisons performed in one or more previous steps 244.

If, responsive to step 248, it is determined that the multi-function sensor will again enter a sleep state, such as to conserve power, the program 239 proceeds to step 214 wherein at least a portion of the multi-function sensor circuitry is suspended or powered down. Entering step 214 may include setting a system tick countdown value or other response condition for satisfying step 240. After step 214, the program again enters step 240.

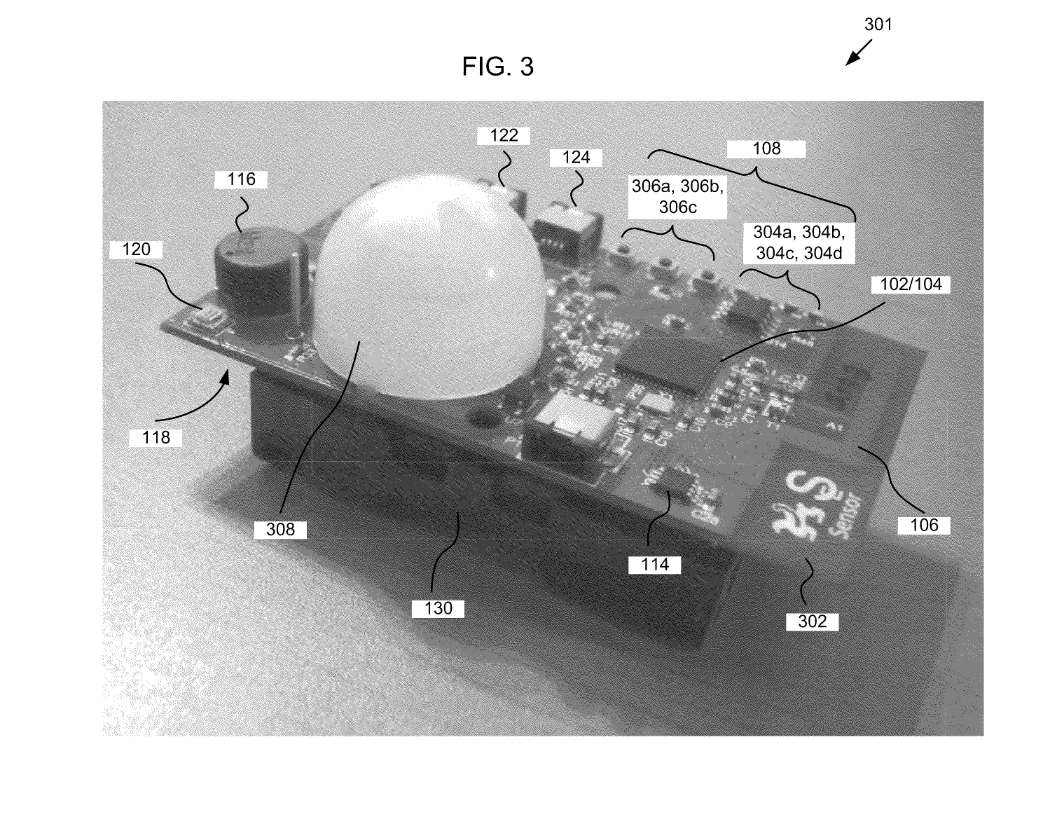

FIG. 3 is a perspective view of an electronics assembly 301 for the multi-function sensor of FIG. 1, according to an embodiment. The electronics assembly 301 includes a printed circuit board 302 onto which electrical components are mounted. A battery holder 130 dominates a back surface of the printed circuit board 302. A user interface 108 may include one or more LEDs 304a, 304b, 304c, and 304d configured to provide multi-function sensor and/or network status information to a user. The user interface 108 may also include one or more buttons 306a, 306b, and 306c configured to receive inquiry and/or command inputs.

A combination controller and network interface 102/104 may, for example, include a FREESCALE™ part number MC13213. The combination controller and network interface 102/104 may be operatively coupled to an antenna 106 embodied as traces formed on the printed circuit board 302. For example, the antenna 106 may be configured as a plane wave antenna tuned to about 2.4 GHz to receive ZigBee™ radio signals. The antenna 106 may be modulatable, such as using a transistor or diodes to selectively couple portions of the antenna 106, or by selectively powering the antenna 106 by coupling the antenna 106 to an RF modulator (not shown). The circuitry to selectively power and/or modify reflectance (as in a backscatter system) of the antenna 106 may included in the controller and network interface 102/104 and/or in external circuitry and devices on the printed circuit board 302.

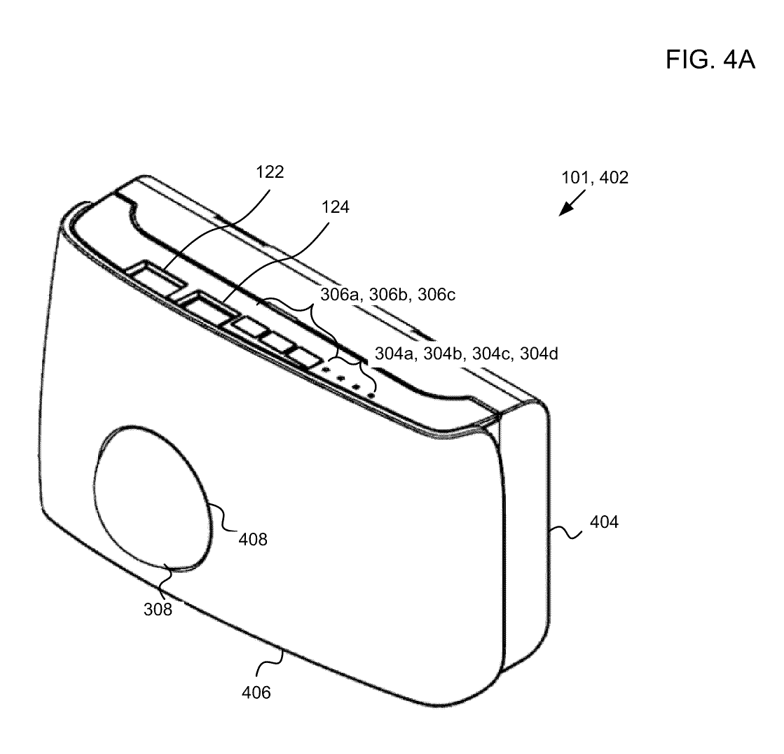

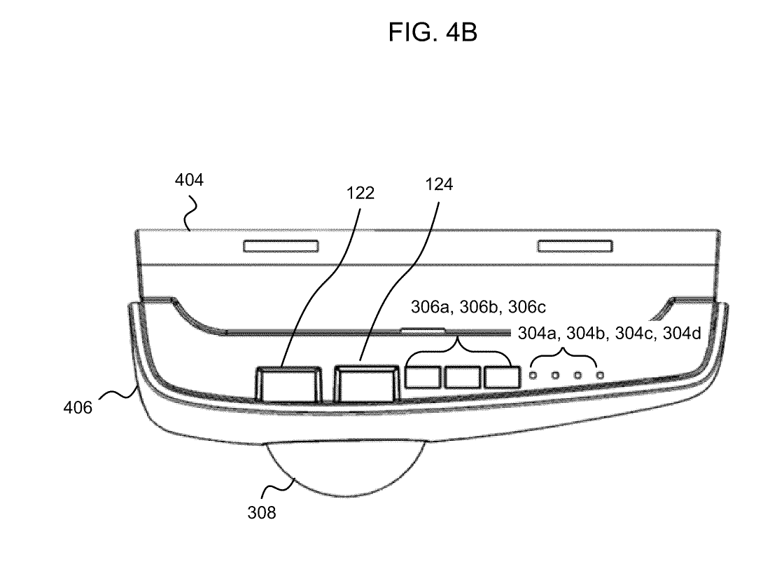

A lens 308, such as a Fresnel lens, may be coupled to the printed circuit board 302, or alternatively to a front cover (depicted in FIG. 4). The Fresnel lens 308 may include a part code FRESNEL available from FUTURLEC ™. Optionally, the lens 308 may include more than one powered optical element. The motion detector (not shown) may be placed behind the lens 308.

A temperature sensor 114 and a humidity sensor 116 such as, respectively an ANALOG DEVICES™ part number ADT75 or ADT75ARMZ and a MEASUREMENT SPECIALTIES™ part number HS1101LF, may be placed as shown. A magnetic sensor 118 may include a HONEYWELL™ two axis magnetic sensor model number HMC1052L disposed on the back of the printed circuit board 302 where indicated. A luminosity sensor 120 may, for example, include a TAOS™ part number TSL2561T available from MOUSER ELECTRONICS, INC.™ Optionally, the luminosity sensor 120 may be placed behind the lens 308 along with the motion detector 112 (not shown). Two external sensor ports 122, 124 may be disposed along an edge of the printed circuit board 302 as shown.

FIG. 4A is a perspective view of the multi-function sensor of FIGS. 1 and 3, according to an embodiment. FIG. 4B is a top view of the multi-function sensor of FIGS. 1, 3 and 4A, according to an embodiment. Description below is with respect to FIGS. 4A and 4B. The multi-function sensor 101 includes a housing 402. The housing 402 may for example include a back plate 404 and a front cover 406.

The front cover 406 may include an aperture 408 configured to provide for penetration by a lens 308 such as a Fresnel disposed over a pyroelectric infrared motion detector 112 (not shown) and a luminosity sensor 120 (not shown). The lens 308 may optionally include an optical power and/or sensitivity axis selected to maximize motion and luminosity detection from a preferred region of a room. According to an embodiment, the axis may be selected by rotating the Fresnel lens 308. According to an embodiment, the optical power may be selected by extending or collapsing a focal length between the Fresnel lens 308 and a circuit board that supports the pyroelectric infrared motion detector 112 and the luminosity sensor 120.

Optionally the back plate 404 and/or front cover 406 may be at least partially shielded to reduce electromagnetic interference. If shielded, a portion of the back plate 404 and front cover 406 should be left unshielded to allow radio frequency energy to reach the antenna (not shown). The back plate 404 and the front cover 406 may be formed as interlocking pieces that may be releasably coupled to one another. According to an embodiment, the front cover 406 may be removed from the back plate 404 by gently squeezing along the top and bottom edges to release mechanical latches (not shown) that couple the front cover 406 and back plate 404 together. The front cover 406 may be snapped into place over the back plate 404 by gently pushing the covers together until the mechanical latches (not shown) fall into detent holding positions. Removing the front cover 406 may provide ready access to the battery carrier (not shown) and the batteries.

The top of the multi-function sensor 101 may include one or more LED indicators 304 and one or more control buttons 306. For example the one or more LED indicators may include momentary indication of a network communication, an indication of power on, an indication of a fault condition such as low battery, an indication of one or more sensed conditions or other indication that may be useful to a user. The one or more buttons 306 may include a display command, a power switch, and one or more manual “turn-on”/“turn-off” command toggles, for example. To conserve battery power, the LED indicators 304 may be normally off. Upon receipt of a display command, the LED indicators 304 may illuminate according to their illumination conditions for at time sufficient for a user to determine the operational state of the multi-function sensor 101. The LEDs may further be context-sensitive and carry different meanings in different operational modes.

Optionally, the Fresnel lens 308 may selectively illuminated, for example by an RGB and/or LED illuminator disposed within the housing 202. When so illuminated, the luminosity sensor 120 may include a filter such as a cold pass or notch filter selected to admit wavelengths other than wavelengths emitted by the RGB and/or LED illuminator. Optionally, the RGB and/or LED illuminator may be configured to output a color or pattern selected to convey information to a user or inhabitant, provide night lighting, provide evacuation lighting, alert a user, or otherwise affect the environment. For example, illumination of the Fresnel lens 308 may be used in conjunction with or in lieu of LED indicators 304 described above, and/or may provide information such as momentary indication of a network communication, an indication of power on, an indication of a fault condition such as low battery, an indication of one or more sensed conditions or other indication that may be useful to a user.

The back plate 404 may optionally include integrated mounting features and/or mounting features configured to couple to mounting hardware. For example one or more screw keyholes, one or more adhesive mounting pads, one or more screw holes, one or more features for mounting to a fire alarm base, one or more legs, one or more hooks and/or eyes, a hook-and-loop fastener pad, and or other features may be provided for permanently or reversibly couple the multi-function sensor 101 to a wall of a home, a shelf, a ceiling, or other mounting surface.

The front cover 406 or other surface of the housing 402 may optionally include indicia selected to explain indications provided by the one or more LEDs and/or selectively illuminated Fresnel lens 308.

As may be appreciated by comparison to the size of the AAA battery holder in FIG. 3, the multi-function sensor 101 may be quite small. According to an embodiment, the longest outer dimensions of the packaging shown in FIG. 4 may be smaller than a credit card. Total outside dimensions may be about 81 mm wide by 46 mm high by 20 mm thick. This small size may further provide for easy and unobtrusive integration, for example in proximity to a moving surface sensed by the magnetic sensor.

As mentioned above, the multi-function sensor 101 may alternatively or additionally be configured to receive AC power. Received AC power may be used in a version of the product that is powered by AC only. Alternatively, the received AC power may be used to charge batteries.

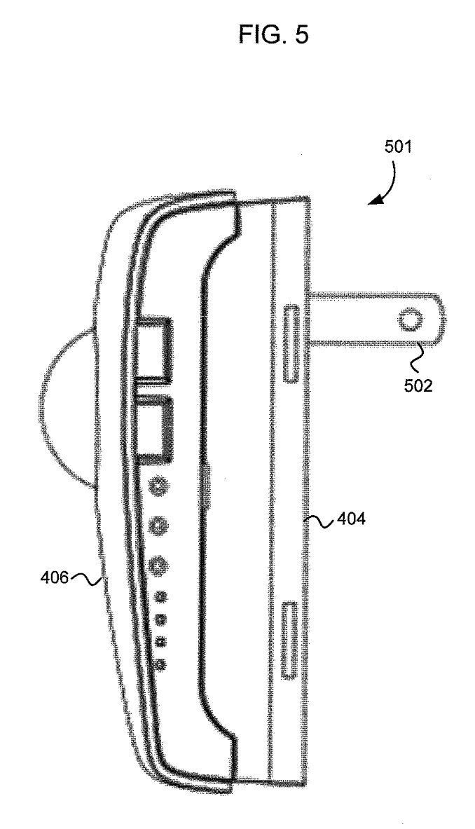

FIG. 5 is a perspective view of a multi-function sensor 501 configured to at least optionally receive AC power through an AC plug 502, according to an embodiment. The package includes a back plate 404 and a front cover 405, which may for example be made from a plastic or metal material. The back plate 404 and the front cover 406 may be formed as interlocking pieces that may be releasably coupled to one another. In other regards, the multi-function sensor 501 includes features described in conjunction with FIGS. 4A-4B.

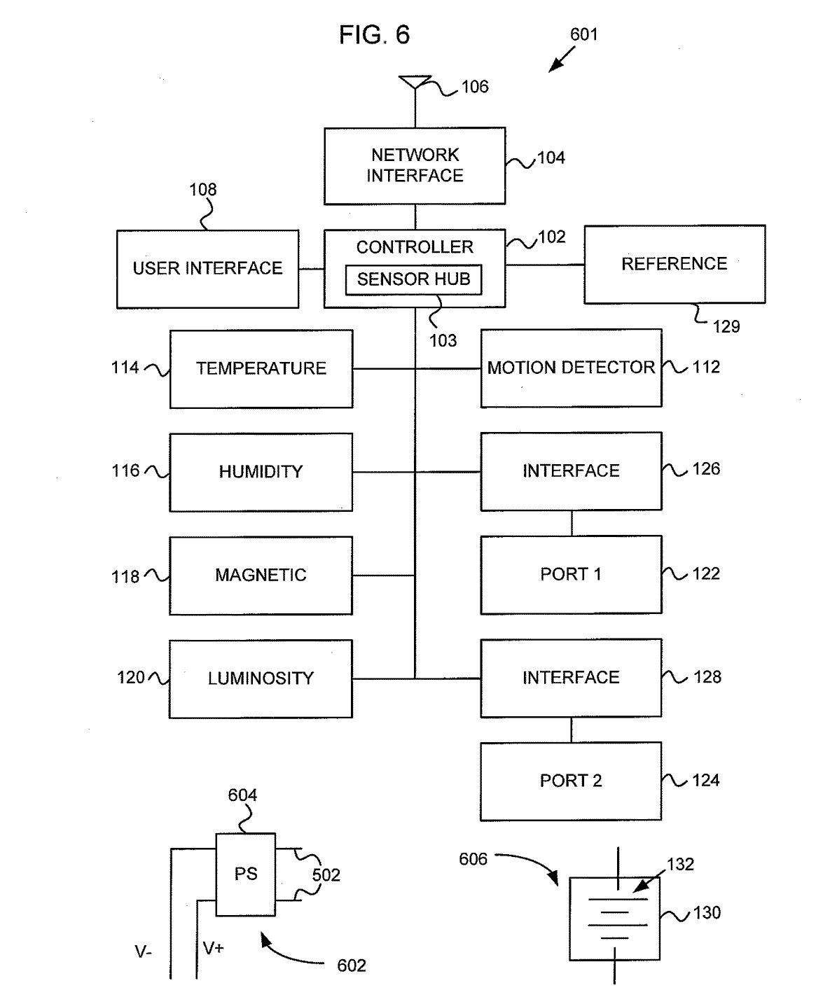

FIG. 6 is a block diagram of the multi-function sensor 601 configured to at least optionally receive AC power through an AC plug 502, according to an embodiment. The structure and functionality of the controller 102, network interface 104 and antenna 106, user interface 108, and relays 110a, 110b, and 110c may be as described above.

With respect to FIGS. 5 and 6, the multi-function sensor 501, 601 may include an AC plug 502. The AC plug 502 is operatively coupled to a power supply 604 configured to output DC voltages V+ and V− to power components associated with the controller 102, network interface 104 and antenna 106, user interface 108, reference 129, motion detector 112, temperature sensor 114, humidity sensor 116, magnetic field sensor 118, luminosity sensor 120, port 1 122 and interface 126, and port 2 124 and interface 128. Optionally, the AC plug 502 and power supply 604 may be configured as an AC power module 602. The AC power module 602 may be built into the multi-function sensor 501, 601 or may be offered as an option or accessory.

Optionally, the multi-function sensor 501, 601 may also include a battery holder 130 configured to receive one or more batteries 132 for powering the wireless relay controller 501, 601. For example, the battery holder 130 may be configured to receive three AAA cells. The AAA cells may be conventional alkaline, NiCd, NiMH, lithium-ion, lithium polymer, or other battery types. Optionally the battery holder 130 may be configured as a battery module 606. The battery module 606 may be built into the multi-function sensor 501, 601 or may be offered as an option or accessory.

Optionally, the AC power module 602 and the battery module 606 may be offered as mutually exclusive options or accessories. According to an embodiment, the AC power module 602 and battery module 606 may operate as a battery charger or an AC power source with battery backup. For example, the AC power module 602 may receive or include sufficient logical control to maintain the batteries 132 in a state of charge, either as primary power or as backup power. According to an embodiment, the operation of the power sources 602, 606 for the multi-function sensor 501, 601 may be programmable to manage power consumption as a function of power availability and/or power cost. For example, the multi-function sensor 501, 601 may include logic to draw power while solar cells are producing power and run from batteries at night, or may include logic to draw power at night to load balance a utility and run from batteries during the daytime.

Optionally, the AC plug 502 may be moved or removed (with or without the power supply 602). Optionally, the AC plug 502 may be rotated or otherwise moved to a recessed position to allow mounting of the multi-function sensor 501, 601 against a flat surface such as a wall. Optionally, the AC plug 502 may provide substantially the entirety of mechanical coupling to a wall (whether or not AC power is provided to the AC plug). Optionally, the back plate 404 of the multi-function sensor 501, 601 may include optional or additional mounting features for mounting the unit to a wall.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A multi-function sensor for a home automation system, comprising:
a network interface configured for data communication with one or more home automation modules;
a plurality of sensors configured to measure a plurality of conditions in a room; and
an electronic controller operatively coupled to the network interface and the plurality of sensors and configured to control operation of one or more of the network interface and the plurality of sensors.

2. The multi-function sensor for a home automation system of claim 1, further comprising:
at least one sensor interface operatively coupled to the controller and configured to receive digital or analog signals from at least one external sensor.

3. The multi-function sensor for a home automation system of claim 1, wherein at least a portion of the network interface and at least a portion of the electronic controller are combined on a single integrated circuit.

4. The multi-function sensor for a home automation system of claim 1 wherein the electronic controller and network interface are configured to wake up from a sleep mode responsive to a sensor input; transmit data corresponding to the sensor input to at least one other module of the home automation system; and go back to sleep after transmitting the data.

5. The multi-function sensor for a home automation system of claim 1 wherein the plurality of sensors include at least two or more of a motion detector, a temperature sensor with humidity sensor, a magnetic sensor, or a luminosity sensor.

6. The multi-function sensor for a home automation system of claim 1, wherein the network interface is configured to receive a configuration from an external system resource; and
wherein the electronic controller is programmed to operate the plurality of sensors according to logic corresponding to the configuration.

7. The multi-function sensor for a home automation system of claim 1, wherein the electronic controller is programmed to operate at least a second sensor responsive to one or more values or functions of values sensed by one or more first sensors.

8. The multi-function sensor for a home automation system of claim 1, wherein the network interface includes a ZigBee™ interface.

9. The multi-function sensor for a home automation system of claim 1, wherein the electronic controller is configured to:
receive a first command;
determine a plurality of sensor operations corresponding to the first command; and
operate one or more of the sensors in accordance with the plurality of sensor operations.

10. The multi-function sensor for a home automation system of claim 9, wherein operating the one or more sensors in accordance with the plurality of sensor operations includes operating at least a portion of the plurality of sensors at least once each corresponding to the plurality of sensor operations.

11. The multi-function sensor for a home automation system of claim 9, wherein the electronic controller includes a microprocessor or microprocessor core and at least one computer memory; and wherein determining the plurality of sensor operations corresponding to the first command includes accessing a lookup table in the at least one computer memory to determine the corresponding plurality or sensor operations.

12. The multi-function sensor for a home automation system of claim 9, wherein at least one of the sensor operations is performed conditional to a sensor value received during another sensor operation.

13. The multi-function sensor for a home automation system of claim 1, further comprising:
a battery holder;
a charging circuit configured to provide DC charging current to the battery holder; and
an AC plug configured to provide power to the charging circuit.

14. The multi-function sensor for a home automation system of claim 13, wherein the AC plug is configured to be moved or recessed to allow mounting the multi-function sensor against a flat surface.

15. A method for operating a multi-function sensor, comprising:
receiving an addressed inquiry from a home automation network resource;
waking up multi-function sensor circuitry from a sleep state;
reading at least one sensor value;
transmitting data responsive to the at least one sensor value; and
re-entering the sleep state.

16. The method for operating a multi-function sensor of claim 15, further comprising:
determining a first command in the addressed inquiry; and
determining a plurality of sensor operations corresponding to the first command.

17. The method for operating a multi-function sensor of claim 16, wherein at least a second of the plurality of sensor operations is conditional upon a sensor value read during a first of the plurality of sensor operations.

18. The method for operating a multi-function sensor of claim 16, wherein determining a plurality of sensor operations corresponding to the first command includes using a lookup table to determine the plurality of sensor operations corresponding to the first command.

19. The method for operating a multi-function sensor of claim 15, further comprising:
responsive to receiving the addressed inquiry, performing address validation and capability validation prior to reading the at least one sensor value.

20. A method for operating a multi-function sensor, comprising:
receiving a first command via a network interface; and
responsive to the first command, performing a plurality of sensor operations.

21. The method for operating a multi-function sensor of claim 20, wherein each sensor operation includes reading a sensor.

22. The method for operating a multi-function sensor of claim 20, further comprising:
using a lookup table to determine the plurality of sensor operations corresponding to the first command.

23. The method for operating a multi-function sensor of claim 20, further comprising:
responsive to receiving the first command via the network interface, performing address validation and capability validation prior to performing the plurality of sensor operations.

24. The method for operating a multi-function sensor of claim 20, wherein at least a second of the plurality of sensor operations is conditional upon a sensor value received during a first of the plurality of sensor operations.

25. The method for operating a multi-function sensor of claim 20, further comprising:
transmitting data corresponding to at least a subset of the plurality of sensor operations.

26. A method for operating a multi-function sensor, comprising:
receiving a system tick;
waking from a sleep mode responsive to receiving the system tick;
reading a sensor value;
transmitting data to a home automation system responsive to the sensor value; and
entering the sleep mode.

27. The method for operating a multi-function sensor of claim 26, wherein transmitting data to a home automation system includes conditionally transmitting data if the sensor value meets one or more criteria for reporting.

28. A multi-function sensor, comprising:
a network interface; and
at least one sensor interface operatively coupled to the network interface and configured to receive digital or analog signals from at least one external sensor;
wherein the network interface is configured to communicate data over a mesh radio network responsive to a signal received through the at least one sensor interface.
